(19) United States
(12) Patent Application Publication
(10) Pub. No.: US 2013/0333459 A1
(43) Pub. Date: Dec. 19, 2013

(54) VALVE STEM FOR A WIRELESS TIRE PRESSURE DETECTOR

(71) Applicant: Hung-Chih YU, Taichung (TW)

(72) Inventor: Hung-Chih YU, Taichung (TW)

(73) Assignee: ORANGE ELECTRONIC CO., LTD., TAICHUNG CITY (TW)

(21) Appl. No.: 13/495,274

(22) Filed: Jun. 13, 2012

(51) Int. Cl. B60C 23/04

(52) U.S. Cl. 73/146.8

(57) ABSTRACT

A valve stem for a wireless tire pressure detector has a tube and a hollow and elastic mounting barrel. The tube has an inflating end, a connecting end, a lower flange, an upper flange and an annular groove. The lower flange is formed on and protrudes from the tube near the connecting end. The upper flange is formed on and protrudes from the tube near the inflating end. The annular groove is formed around the tube between the flanges. The mounting barrel is securely mounted around the tube between the flanges and has an engaging segment, a mounting segment, a mounting hole and an annular protrusion. The engaging segment abuts against the lower flange. The mounting segment is formed with the engaging segment and abuts against the upper flange. The annular protrusion is formed on and protrudes from an internal surface of the mounting barrel and engages the annular groove.

### BACKGROUND OF THE INVENTION

1. Field of Invention

The present invention relates to a valve stem, and more particularly to a valve stem that can be detached and replaced from a wireless tire pressure detector easily and can provide a preferred receiving effect to the wireless tire pressure detector.

2. Description of the Related Art

A conventional tire pressure monitoring system (TPMS) can be classified a direct-type TPMS and an indirect-type TPMS. The direct-type TPMS has a tire pressure detector mounted in a tire to directly detect the air pressure of the tire and to enable the driver to know the actual air pressure of the tire to keep the tire in a stable condition. The indirect-type TPMS has a wheel speed sensor mounted in a braking system of a car to detect the air pressure of the tire by comparing the speed difference of the wheels of the car. With the advances in wireless communication technology, the direct-type TPMS has gradually become the trend of a variety of cars to assemble.

The conventional direct-type TPMS is mounted on a rim and is connected to an electronic system of a car by wireless communication to provide the air pressure of the tire to the user. In order to mount a wireless tire pressure detector of the conventional direct-type TPMS on the rim, a metallic valve stem is mounted through the rim, is connected to the wireless tire pressure detector and has a tube and an outer barrel. The tube has a connecting end and an inflating end. The connecting end of the valve stem extends into the rim, is connected to the wireless tire pressure detector and has a shape corresponding to a shape of the wireless tire pressure detector. A bolt is mounted through the wireless tire pressure detector and is connected to the valve stem to connect the valve stem with the wireless tire pressure detector. The inflating end of the vale stem extends out of the rim. The outer barrel is made of rubber material and is securely mounted around the tube by a bonding technique. The outer barrel abuts against the rim to provide a sealing effect to the tire.

However, the conventional valve stem is mounted on the rim of the tire, when the tire is received an external impact or collision, the outer barrel may be compressed and cannot closely fit the rim of the tire and this may cause the air stored in the tire to leak. In addition, because the tire is filled with ozone, rubber is easy to produce oxidation with ozone, ant this will cause the outer barrel to lose its elasticity and need to replace with a new valve stem in the next year. In addition, the outer barrel of the conventional valve stem is securely mounted around the tube and is uneasy to separate from the tube. The user needs to heat and to melt the outer barrel or uses equipments to direct damage the outer barrel, and this is difficult to replace the valve stem and may require specific stores to replace the valve stem.

Another conventional valve stem for a wireless tire pressure detector has a tube, a mounting element and an annular ring. The tube also has a connecting end and an inflating end. The mounting element is made of rubber material, is mounted around the tube between the connecting end and the inflating end of the tube and has a larger diameter segment adjacent to the connecting end of the tube to engage an inner wall of the rim. The annular ring is screwed with the tube and engages an outer wall of the rim to enable the mounting element to fit with the rim so as to provide a sealing effect to the tire. However, when the valve stem is replaced, the annular ring has to be rotated to separate from the tube but this will spend a lot of time. Additionally, in order to prevent the rim from damaging by the annular ring or to prevent the thread of the annular ring from breaking, a thread combinating device that has a twisting force measuring meter is needed to use in operations and this is inconvenient in replacement.

In addition, the conventional wireless tire pressure detector has an antenna to connect with a tire pressure monitoring equipment in the car, and the antenna will increase the volume of the conventional wireless tire pressure detector that is mounted in the rim. In addition, the antenna is mounted and hidden in the conventional wireless tire pressure detector, but this will influence the connecting effect between the conventional wireless tire pressure detector and the tire pressure monitoring equipment.

The valve stem for a wireless tire pressure detector in accordance with the present invention mitigates or obviates the aforementioned problems.

### SUMMARY OF THE INVENTION

The primary objective of the present invention is to provide a valve stem that can be detached and replaced from a wireless tire pressure detector easily and can provide a preferred receiving effect to the wireless tire pressure detector.

The valve stem for clamping wireless tire pressure detector in accordance with the present invention has a tube and a hollow and elastic mounting barrel. The tube has an inflating end, a connecting end, a lower flange, an upper flange and an annular groove. The lower flange is annularly formed on and protrudes from the tube near the connecting end. The upper flange is annularly formed on and protrudes from the tube near the inflating end. The annular groove is formed around the tube between the flanges. The mounting barrel is securely mounted around the tube between the flanges and has an engaging segment, a mounting segment, a mounting hole and an annular protrusion. The engaging segment abuts against the lower flange. The mounting segment is formed with the engaging segment and abuts against the upper flange. The annular protrusion is annularly formed on and protrudes from an internal surface of the mounting barrel in the mounting hole and engages the annular groove to enable the mounting barrel to securely mount around the tube.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a valve stem for a wireless tire pressure detector in accordance with the present invention and a wireless tire pressure detector;

FIG. 2 is an exploded perspective view of the valve stem in FIG. 1;

FIG. 3 is a side view in partial section of the valve stem in FIG. 1;

FIG. 4 is an operational side view in partial section of the valve stem in FIG. 1, showing the valve stem mounted through a rim of a tire and holding a wireless tire pressure detector;

FIG. 5 is an exploded perspective view of a second embodiment of a valve stem for a wireless tire pressure detector in accordance with the present invention and a wireless tire pressure detector;

FIG. 6 is an exploded perspective view of the valve stem in FIG. 5; and

FIG. 7 is a side view in partial section of the valve stem in FIG. 5.

### DETAILED DESCRIPTION OF THE INVENTION

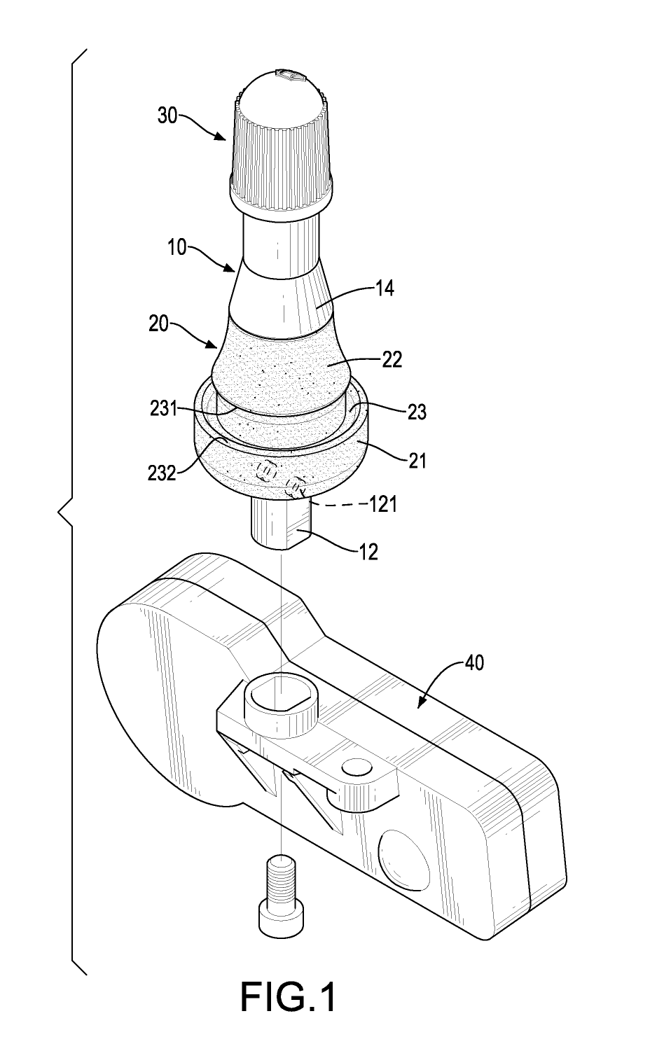

With reference to FIG. 1, a first embodiment of a valve stem for a wireless tire pressure detector 40 having a connecting hole with a shape in accordance with the present invention has a hollow tube 10, a hollow and elastic mounting barrel 20 and a cover 30.

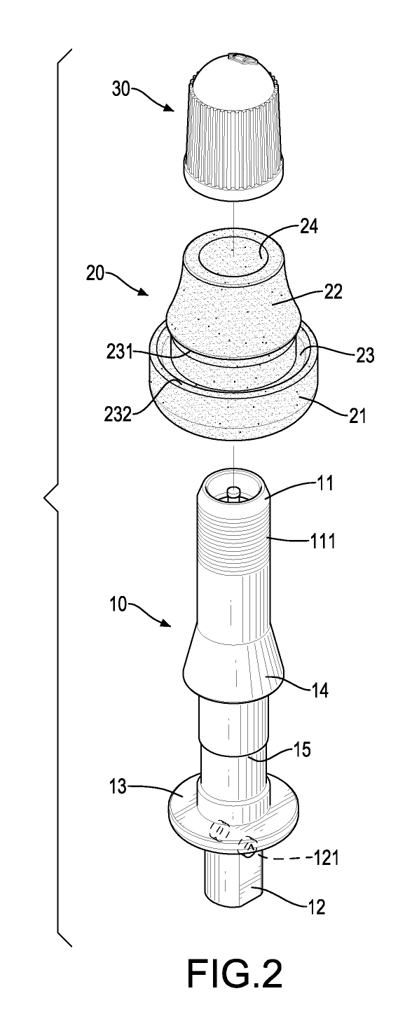

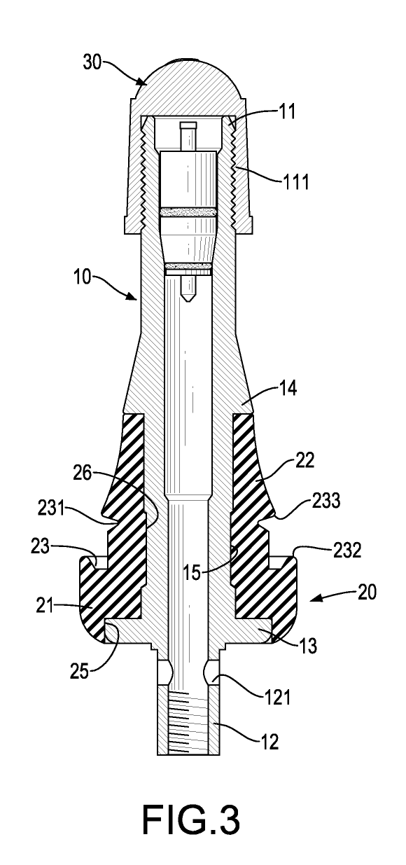

With further reference to FIGS. 2 and 3, the tube 10 has an external surface, an inflating end 11, a connecting end 12, a lower flange 13, an upper flange 14 and an annular groove 15. Preferably, the tube 10 is made of metal and can be severed as an antenna of the wireless tire pressure detector 40. The inflating end 11 of the tube 10 is used to connect to an inflating device and has an external surface and an outer thread 111 formed around the external surface of the inflating end 11 of the tube 10. The connecting end 12 of the tube 10 is formed with the inflating end 11 and has a shape corresponding to the shape of the connecting hole of the wireless tire pressure detector 40 and a gas hole 121 radially formed through the external surface of the tube 10.

The lower flange 13 may be a disc form, is annularly formed on and protrudes from the external surface of the tube 10 near the connecting end 12 of the tube 10 and has a diameter. The upper flange 14 is annularly formed on and protrudes from the external surface of the tube 10 near the outer thread 111 of the inflating end 11 of the tube 10 and has a bottom end, an top end, a maximal diameter and a minimal diameter. The top end of the upper flange 14 is defined adjacent to the outer thread 111 of the inflating end 11. The maximal diameter of the upper flange 14 is defined at the bottom end of the upper flange 14. The minimal diameter of the upper flange 14 is defined at the top end of the upper flange 14. The diameter of the upper flange 14 is gradually reduced from the bottom end to the top end of the upper flange 14. In addition, the maximal diameter of the upper flange 14 is smaller than the diameter of the lower flange 13. The annular groove 15 is formed around the external surface of the tube 10 between the lower flange 13 and the upper flange 14.

The mounting barrel 20 is made of an elastic rubber material, is securely mounted around the tube 10 between the flanges 13, 14 and has a bottom end, a top end, an internal surface, an engaging segment 21, a mounting segment 22, a holding segment, a mounting hole 24, a mounting recess 25 and an annular protrusion 26. The engaging segment 21 is formed on and protrudes from the bottom end of the mounting barrel 20, abuts against the lower flange 13 of the tube 10 and has a diameter, a top face and a bottom face. The mounting segment 22 is formed on and protrudes from the top end of the mounting barrel 20, is formed with the engaging segment 21 of the mounting barrel 20 and abuts against the upper flange 14 of the tube 10. The mounting segment 22 has a top end, a bottom end and a diameter. The top end of the mounting segment 22 abuts against the bottom end of the upper flange 14. The diameter of the mounting segment 22 is gradually reduced from the bottom end to the top end of the mounting segment 22. The diameter of the mounting segment 22 is smaller than the diameter of the engaging segment 21.

The holding segment is formed on and protrudes from the mounting barrel 20 between the engaging segment 21 and the mounting segment 22 and has a holding recess 23, a mounting groove 231, a first abutting ring 232 and a second abutting ring 233. The holding recess 23 is annularly formed in the top face of the engaging segment 21. The mounting groove 231 is annularly formed around the mounting segment 22 above the holding recess 23. The first abutting ring 232 is annularly formed on the top face of the engaging segment 21 around the holding recess 23 and below the mounting groove 231. The second abutting ring 233 is annularly formed on and protrudes from the mounting segment 22 above the mounting groove 231.

The mounting hole 24 is axially formed through the engaging segment 21 and the mounting segment 22 of the mounting barrel 20 and has a diameter. The mounting recess 25 is axially formed through the bottom face of the engaging segment 21, communicates with the mounting hole 24 and is mounted around the lower flange 13 of the tube 10. The mounting recess 25 has a diameter larger than the diameter of the mounting hole 24. The annular protrusion 26 is annularly formed on and protrudes from the internal surface of the mounting barrel 20 in the mounting hole 24 between the engaging segment 21 and the mounting segment 22 and engages the annular groove 15 of the tube 10 to enable the mounting barrel 20 to securely mount around the tube 10.

The cover 30 is connected to inflating end 11 of the tube 10 and has an inner thread screwed with the outer thread 111 of the inflating end 11.

With reference to FIG. 1, the connecting end 12 of the tube 10 is connected to the wireless tire pressure detector 40, the tube 10 can be severed as an antenna of the wireless tire pressure detector 40 by the metallic tube 10 and this can provide a strength gain in an area to enhance the directivity of the wireless signal transmission of the wireless tire pressure detector 40.

According to the above-mentioned, the mounting barrel 20 is elastic and can be deformed to mount around the tube 10 between the flanges 13, 14. When the mounting barrel 20 is mounted around the tube 10, the mounting segment 22 abuts against the upper flange 14, the engaging segment 21 abuts against the lower segment 13 and the annular protrusion 26 engages the annular groove 15. Then, the mounting barrel 20 can be securely limited and mounted around the tube 10 between the flanges 13, 14 to prevent the mounting barrel 20 from slipping from the tube 10. Furthermore, the mounting recess 25 of the mounting barrel 20 is mounted around the lower flange 13 of the tube 10 and this also can provide a further holding effect to the mounting barrel 20.

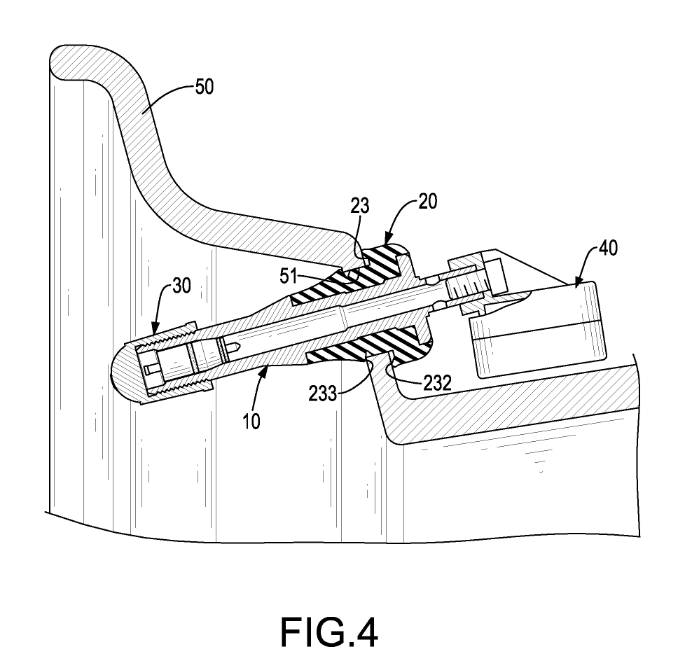

With reference to FIG. 4, the first embodiment of the valve stem in accordance with the present invention is mounted through a hole 51 of a rim 50 from an inner side to an outer side of the rim 50 to enable the inflating end 11 to extend out the outer side of the rim 50 and the connecting end 12 is mounted in the inner side of the rim 50 to connect with the wireless tire pressure detector 40. When the valve stem is mounted in the rim 50, the mounting barrel 20 can be deformed to mount through the hole 51 of the rim 50. The diameter of the mounting segment 22 of the mounting barrel 20 is larger than a diameter of the hole 51 of the rim 50. Then, the hole 51 of the rim 50 can securely engage the mounting barrel 20 between the engaging segment 21 and the mounting segment 22 to enable the abutting rings 232, 233 respectively abut against the outer side and the inner side of the rim 50 beside the hole 51, and this can provide a preferred sealing effect to the rim 50.

When a user wants to replace the mounting barrel 20, the mounting barrel 20 can be separated from the hole 51 of the rim 50 by pulling the valve stem, and the mounting barrel 20 can be detached from the tube 10 by an external force to deform the mounting barrel 20 without using specific tools or heating and melting the mounting barrel 20. In addition, the abutting rings 232, 233 of the mounting barrel 20 can enable the mounting barrel 20 to closely abut with the rim 50 and this can prevent the mounting barrel 20 separating from the rim 50 when the tire is received an external impact or collision.

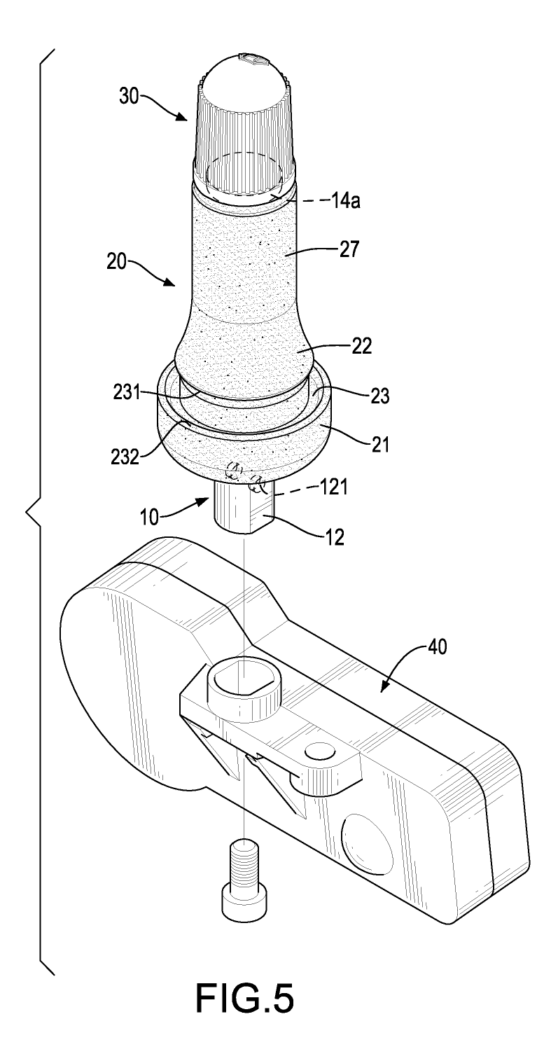

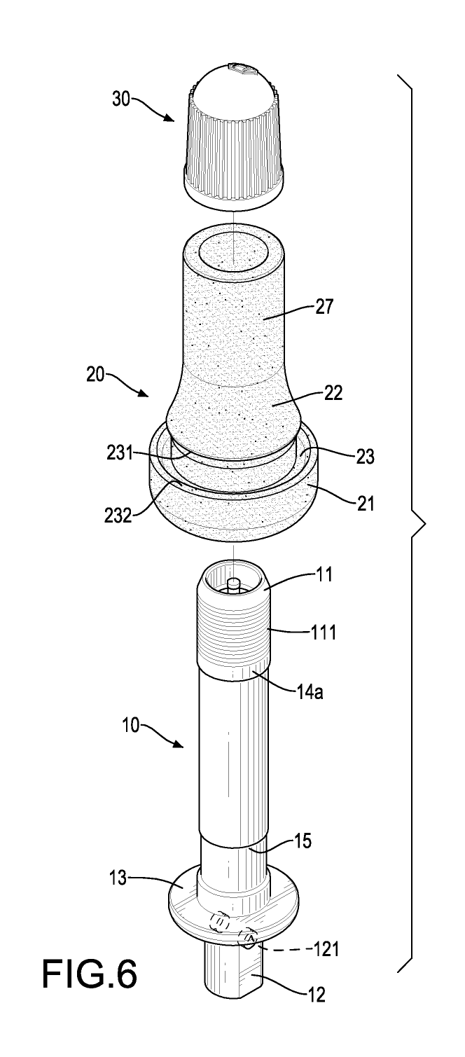

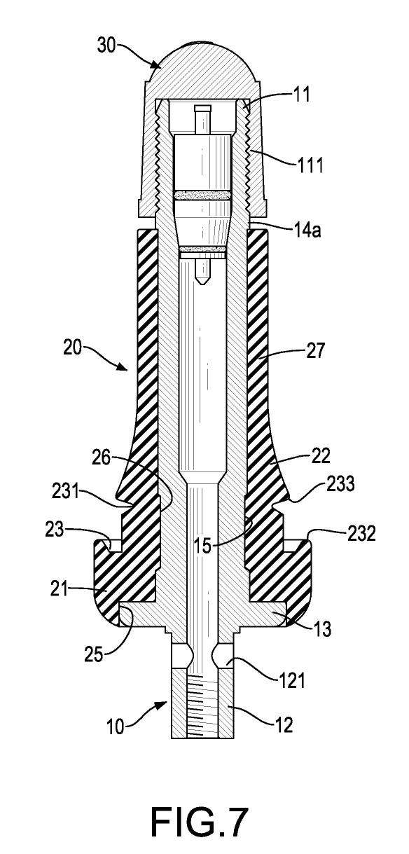

With reference to FIGS. 5 to 8, a second embodiment of a valve stem for a wireless tire pressure detector 40 in accordance with the present invention has a similar structures and relationship as the first embodiment of a valve stem except that the upper flange 14a is annularly formed on and protrudes from the external surface of the tube 10 at the outer thread 111 of the inflating end 11 of the tube 10 and has a flat-shape. In addition, the mounting barrel 20 further has an extending segment 27 formed with the mounting segment 22 opposite to the engaging segment 21 and abutting against the upper flange 14a.

The valve stem for a wireless tire pressure detector 40 as described has the following advantages.

1. The valve stem in accordance with the present invention has an elastic mounting barrel 20 securely mounted around the tube 10 between the flanges 13, 14, 14a, and the annular protrusion 26 of the mounting barrel 20 engages the annular groove 15 of the tube 10 and this can enable the mounting barrel 20 to securely mount around the tube 10. When the mounting barrel 20 is needed to replace, the mounting barrel 20 can be deformed by an external force to separate from the tube 10 without using specific tools and this is convenient in assemble and maintain.

2. The annular protrusion 26 of the mounting barrel 20 engages the annular groove 15 of the tube 10 to provide a preferred holding effect to the mounting barrel 20. In addition, when the vale stem is mounted in the hole 51 of the rim 50, the abutting rings 232, 233 can respectively abut the sides of the rim 50 beside the hole 51 to prevent the mounting barrel 20 separating from the rim 50.

3. The valve stem in accordance with the present invention only needs a simple equipment or hands to separate the mounting barrel 20 from the tube 10 without heating and melting the mounting barrel 20, can be widely used in car preparation plant or tire fitting shops without using professional dismantling or assembly of equipment and this can reduce costs for the valve stem.

4. The tube of the valve stem in accordance with the present invention is made of metal material, can be used as the antenna to provide the strength in the region to enhance the directivity of the wireless signal transmitter of the wireless tire pressure detector 40 and this can enable the tire pressure monitoring equipment in the car to maintain the recipient stability.

What is claimed is:

1. A valve stem for a wireless tire pressure detector comprising:
a tube being adapted to connect with the wireless tire pressure detector and having
an external surface;
an inflating end;
a connecting end formed with the inflating end and being adapted to connect with the wireless tire pressure detector;
a lower flange annularly formed on and protruding from the external surface of the tube near the connecting end of the tube;
an upper flange annularly formed on and protruding from the external surface of the tube near the outer thread of the inflating end of the tube; and
an annular groove formed around the external surface of the tube between the lower flange and the upper flange; and
a hollow and elastic mounting barrel securely mounted around the tube between the flanges and having
a bottom end;
a top end;
an internal surface;
an engaging segment formed on and protruding from the bottom end of the mounting barrel, abutting against the lower flange of the tube and having a top face;
a mounting segment formed on and protruding from the top end of the mounting barrel, formed with the engaging segment of the mounting barrel and abutting against the upper flange of the tube;
a mounting hole axially formed through the engaging segment and the mounting segment of the mounting barrel; and
an annular protrusion annularly formed on and protruding from the internal surface of the mounting barrel in the mounting hole between the engaging segment and the mounting segment and engaging the annular groove of the tube to enable the mounting barrel to securely mount around the tube.

2. The valve stem as claimed in claim 1, wherein the connecting end of the tube has a gas hole radially formed through the external surface of the tube.

3. The valve stem as claimed in claim 2, wherein
the engaging segment has a bottom face;
the mounting hole has a diameter; and
the mounting barrel has a mounting recess axially formed through the bottom face of the engaging segment, communicating with the mounting hole and mounted around the lower flange of the tube and having a diameter larger than the diameter of the mounting hole.

4. The valve stem as claimed in claim 2, wherein the mounting barrel has a holding segment formed on and protruding from the mounting barrel between the engaging segment and the mounting segment and having
a holding recess annularly formed in the top face of the engaging segment; and
a mounting groove annularly formed in the mounting segment above the holding recess.

5. The valve stem as claimed in claim 2, wherein the mounting segment has
a top end abutting against the upper flange;
a bottom end; and
a diameter being gradually reduced from the bottom end to the top end of the mounting segment.

6. The valve stem as claimed in claim 1, wherein the holding segment of the mounting barrel has
a first abutting ring annularly formed on the top face of the engaging segment; and
a second abutting ring annularly formed on and protruding from the mounting segment.

7. The valve stem as claimed in claim 2, wherein the holding segment of the mounting barrel has
a first abutting ring annularly formed on the top face of the engaging segment; and
a second abutting ring annularly formed on and protruding from the mounting segment.

8. The valve stem as claimed in claim 3, wherein the holding segment of the mounting barrel has
a first abutting ring annularly formed on the top face of the engaging segment; and
a second abutting ring annularly formed on and protruding from the mounting segment.

9. The valve stem as claimed in claim 4, wherein the holding segment of the mounting barrel has
a first abutting ring annularly formed on the top face of the engaging segment around the holding recess below the mounting groove; and
a second abutting ring annularly formed on and protruding from the mounting segment above the mounting groove.

10. The valve stem as claimed in claim 5, wherein the holding segment of the mounting barrel has
a first abutting ring annularly formed on the top face of the engaging segment; and
a second abutting ring annularly formed on and protruding from the mounting segment.

11. The valve stem as claimed in claim 1, wherein
the engaging segment has a bottom face;
the mounting hole has a diameter; and
the mounting barrel has a mounting recess axially formed through the bottom face of the engaging segment, communicating with the mounting hole and mounted around the lower flange of the tube and having a diameter larger than the diameter of the mounting hole.

12. The valve stem as claimed in claim 11, wherein the holding segment of the mounting barrel has
a first abutting ring annularly formed on the top face of the engaging segment; and
a second abutting ring annularly formed on and protruding from the mounting segment.

13. The valve stem as claimed in claim 1, wherein the mounting barrel has a holding segment formed on and protruding from the mounting barrel between the engaging segment and the mounting segment and having
a holding recess annularly formed in the top face of the engaging segment; and
a mounting groove annularly formed in the mounting segment above the holding recess.

14. The valve stem as claimed in claim 13, wherein the holding segment of the mounting barrel has
a first abutting ring annularly formed on the top face of the engaging segment around the holding recess below the mounting groove; and
a second abutting ring annularly formed on and protruding from the mounting segment above the mounting groove.

15. The valve stem as claimed in claim 1, wherein the mounting segment has
a top end abutting against the upper flange;
a bottom end; and
a diameter being gradually reduced from the bottom end to the top end of the mounting segment.

16. The valve stem as claimed in claim 15, wherein the holding segment of the mounting barrel has
a first abutting ring annularly formed on the top face of the engaging segment; and
a second abutting ring annularly formed on and protruding from the mounting segment.
